(19) United States
(12) Patent Application Publication
(10) Pub. No.: US 2023/0362070 A1
(43) Pub. Date: Nov. 9, 2023

(54) SIMILARITY-BASED CATEGORIZATION FOR COLLECTION TREATMENT INCORPORATING FUTURE CUSTOMER RELATIONSHIP MANAGEMENT (CRM) CHANNELS

(71) Applicant: AT&T Intellectual Property I, L.P., Atlanta, GA (US)

(72) Inventors: Wen-Ling Hsu, Bridgewater, NJ (US); Jing Guo, Olney, MD (US); Wen Wang, Marietta, GA (US); Zhengyi Zhou, Chappaqua, NY (US); Eric Zavesky, Austin, TX (US)

(73) Assignee: AT&T Intellectual Property I, L.P., Atlanta, GA (US)

(21) Appl. No.: 17/738,624

(22) Filed: May 6, 2022

(51) Int. Cl. H04L 41/5061; H04L 41/5067

(52) U.S. Cl. CPC H04L 41/5064; H04L 41/5067

(57) ABSTRACT

Aspects of the subject disclosure may include, for example, obtaining a list of a plurality of communication channels, each communication channel being associated with at least one respective feature of a plurality of features; correlating each communication channel in the list with at least one respective user response of a plurality of user responses; receiving an identification of a new communication channel that does not exist in the list, the new communication channel being associated with at least one feature of the plurality of features; determining, based upon the at least one feature that is associated with the new communication channel, with which one or more of the plurality of communication channels in the list the new communication channel is similar, resulting in a determination; and assigning, based upon the determination, at least one of the plurality of user responses to the new communication channel. Other embodiments are disclosed.

### FIELD OF THE DISCLOSURE

The subject disclosure relates to a similarity-based categorization for collection treatment incorporating future customer relationship management (CRM) channels.

### BACKGROUND

Treatments in domains such as customer relationship management (CRM) are often limited to existing channels (e.g., telephone calls, emails, and text messages). With constant evolution in technology, new treatments continue to emerge. Without deploying the new treatment/channel, there has typically been little or no data to train the models (e.g., only data on limited treatment that has existed/been tested is typically available to leverage for modeling). Further, without model results, there has typically been no way to find out whether the new treatment/channel would be effective (e.g., existing model often does not consider future unknown treatment/channel.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function fully or partially within the communication network of FIG. 1) in accordance with various aspects described herein.

FIG. 2B is a block diagram illustrating an example, non-limiting embodiment of a system (which can function fully or partially within the communication network of FIG. 1) in accordance with various aspects described herein.

FIG. 2C is a block diagram illustrating an example, non-limiting embodiment of a system (which can function fully or partially within the communication network of FIG. 1) in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for categorizing, simulating, and implementing communication channels and/or business actions (e.g., in the context of customer relationship management). Other embodiments are described in the subject disclosure.

One or more aspects of the subject disclosure include building a model based on existing CRM treatment methods (e.g., communication channel(s) and/or business action(s)) and using output from the model to provide a treatment recommendation for a new treatment (e.g., communication channel(s) and/or business action(s)) that does not exist in current training data. In various examples, techniques described herein can be applied in the context of CRM or can be applied to treatment strategies in other domains, such as future remote learning.

One or more aspects of the subject disclosure include utilizing fuzzy match to incorporate future treatment methods (e.g., communication channel(s) and/or business action(s)) into an existing process, thus providing flexibility to account for the unknown.

One or more aspects of the subject disclosure include converting a one-dimensional categorical variable into multi-dimensional numerical variables (in one example, this converting can be done in a way that a new category can be easily scored by using features of existing models to simulate a new emerging channel).

One or more aspects of the subject disclosure include a multi-dimensional representation of treatment methods (e.g., integrating business rules/attributes) to incorporate new treatment method without retraining.

One or more aspects of the subject disclosure include expanding potential future treatment methods by examining the similarity of a new treatment/channel to one or more existing treatments/channels (and determining which method to design to best achieve business goals). In one example, a mechanism facilitates conceptualizing a new recommendation of effective channel(s) before they even exist. In one example, a mechanism facilitates anticipation of likely future interactions of the users (which can be beneficial for resource and/or workforce capacity planning).

One or more aspects of the subject disclosure include a device comprising: a processing system including a processor; and a memory that stores executable instructions that, when executed by the processing system, facilitate performance of operations, the operations comprising: obtaining a list of a plurality of communication channels, each communication channel being associated with at least one respective feature of a plurality of features; correlating each communication channel in the list with at least one respective user response of a plurality of user responses; receiving an identification of a new communication channel that does not exist in the list, the new communication channel being associated with at least one feature of the plurality of features; determining, based upon the at least one feature that is associated with the new communication channel, with which one or more of the plurality of communication channels in the list the new communication channel is similar, resulting in a determination; and assigning, based upon the determination, at least one of the plurality of user responses to the new communication channel.

One or more aspects of the subject disclosure include a non-transitory machine-readable medium comprising executable instructions that, when executed by a processing system including a processor, facilitate performance of operations, the operations comprising: receiving identification of a plurality of communication channels; receiving, for each communication channel of the plurality of communication channels, identification of one or more respective associated features of a plurality of features; correlating each communication channel of the plurality of communication channels with one or more respective customer responses of a plurality of customer responses; receiving identification of a new communication channel; receiving, for the new communication channel, identification of one or more associated features of the plurality of features; determining, based upon the one or more features that are associated with the new communication channel, with which particular one or more of the plurality of communication channels the new communication channel corresponds, resulting in a determination; and associating, based upon the determination, a particular one of the plurality of customer responses with the new communication channel.

One or more aspects of the subject disclosure include a method comprising: receiving a list of a plurality of customer-contact communication channels, each customer-contact communication channel being associated with a respective customer-contact feature of a plurality of customer-contact features; coupling each customer-contact communication channel in the list to a respective customer response of a plurality of customer responses; receiving data identifying a new customer-contact communication channel that does not exist in the list, the new customer-contact communication channel being associated with a customer-contact feature of the plurality of customer-contact features; determining, based upon the customer-contact feature that is associated with the new customer-contact communication channel, with which one or more of the plurality of customer-contact communication channels in the list the new customer-contact communication channel is similar, resulting in a determination; and assigning, based upon the determination, a particular one of the plurality of customer responses to the new customer-contact communication channel.

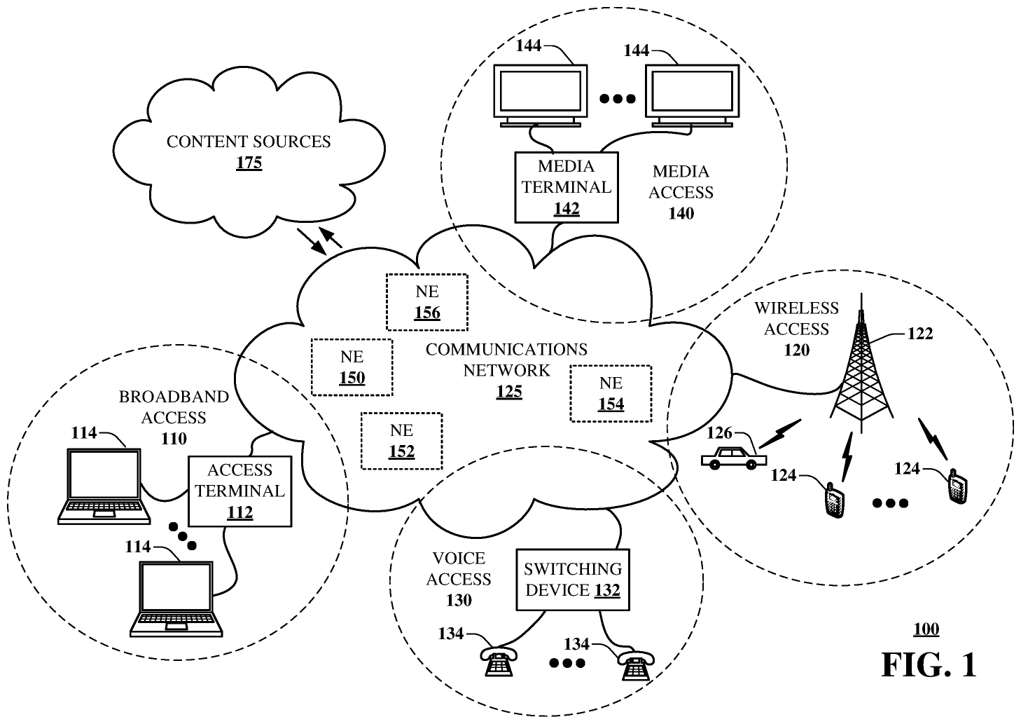

Referring now to FIG. 1, a block diagram is shown illustrating an example, non-limiting embodiment of a system 100 in accordance with various aspects described herein. For example, system 100 can facilitate in whole or in part categorizing, simulating, and implementing communication channels and/or business actions (e.g., in the context of customer relationship management). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

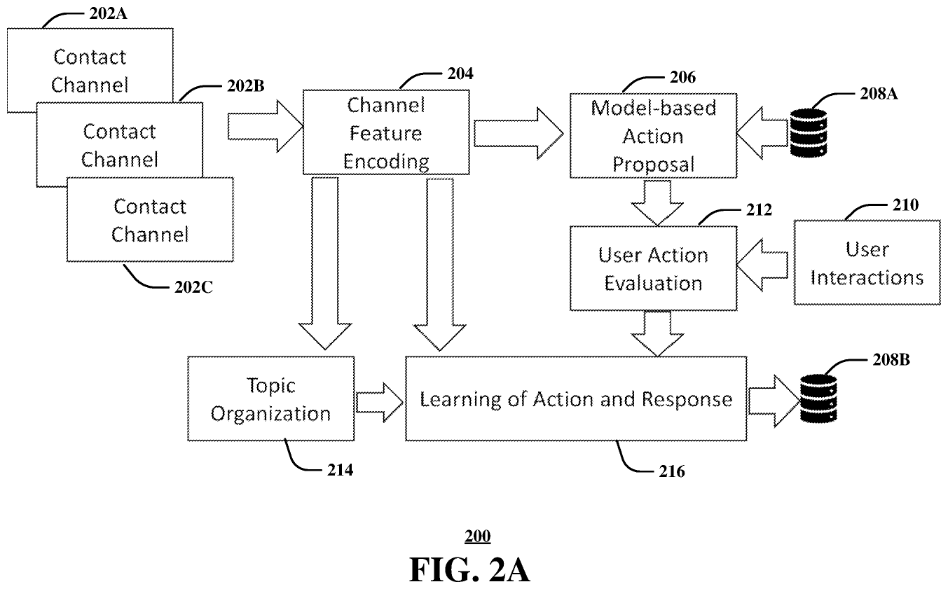

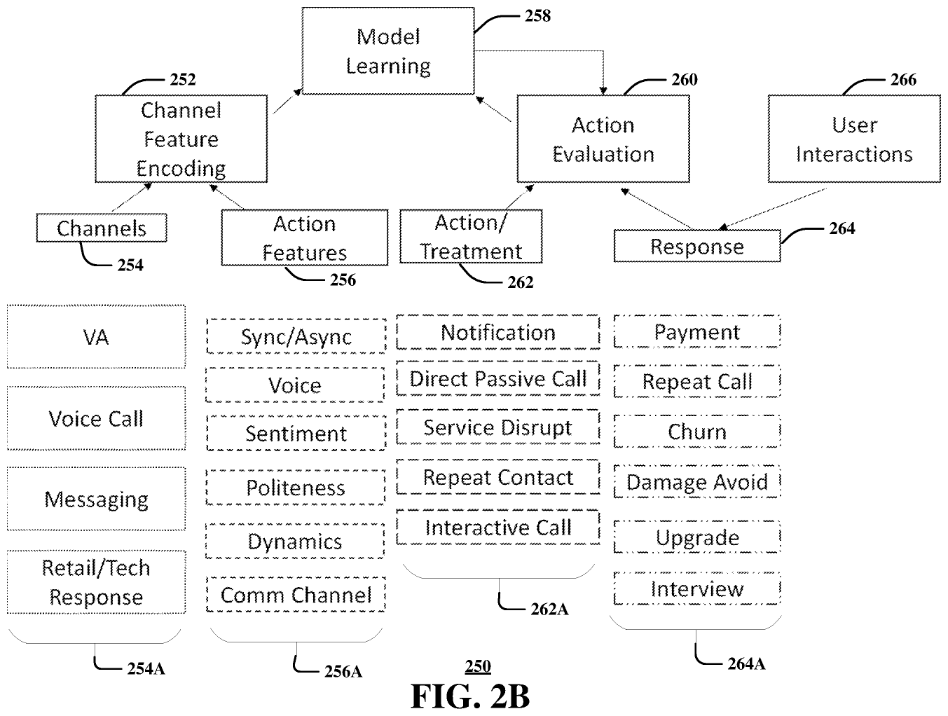

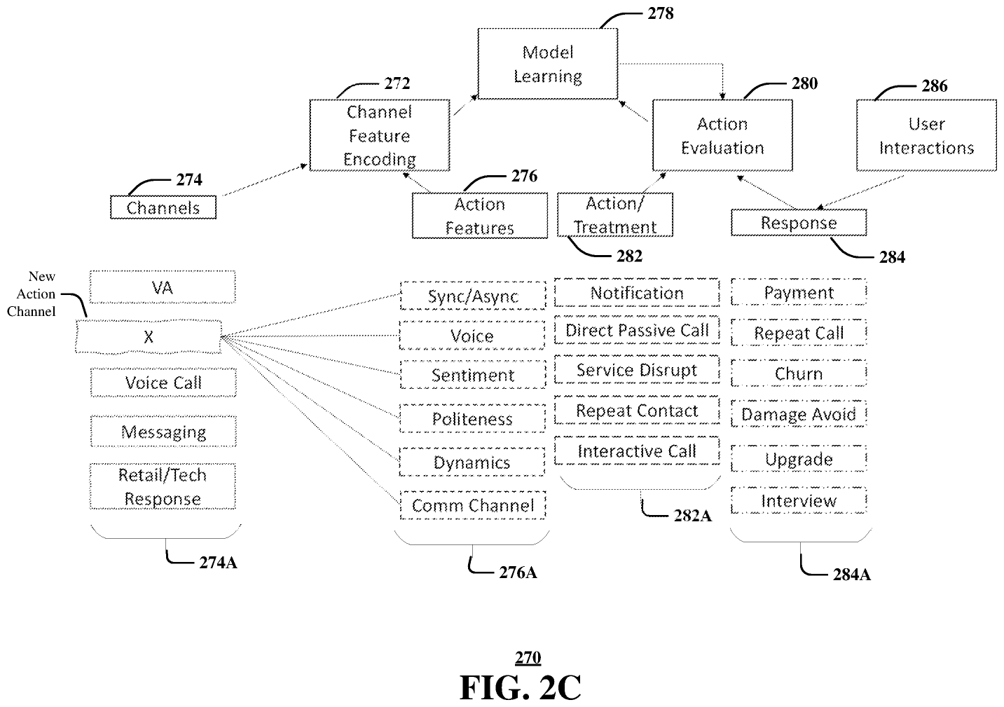

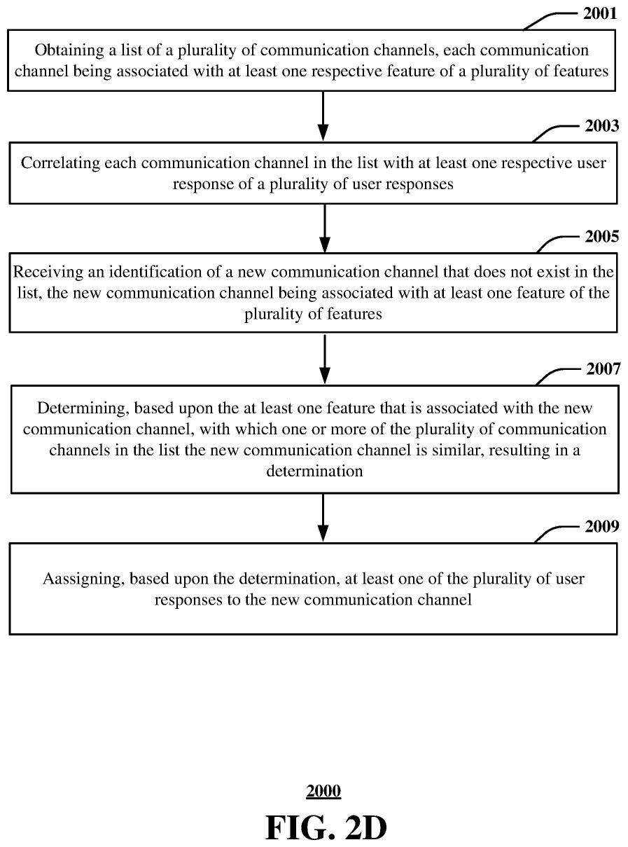

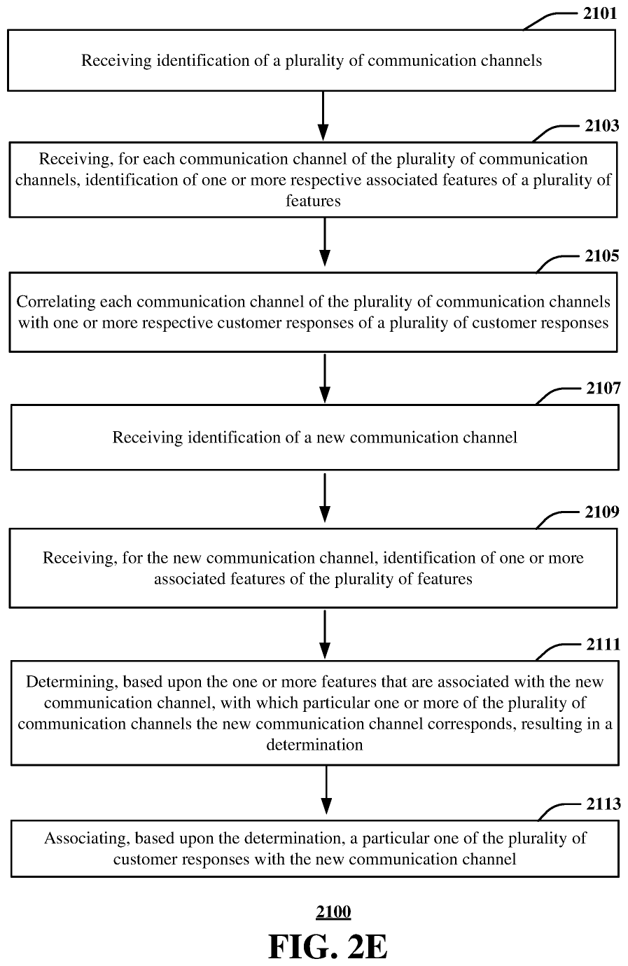

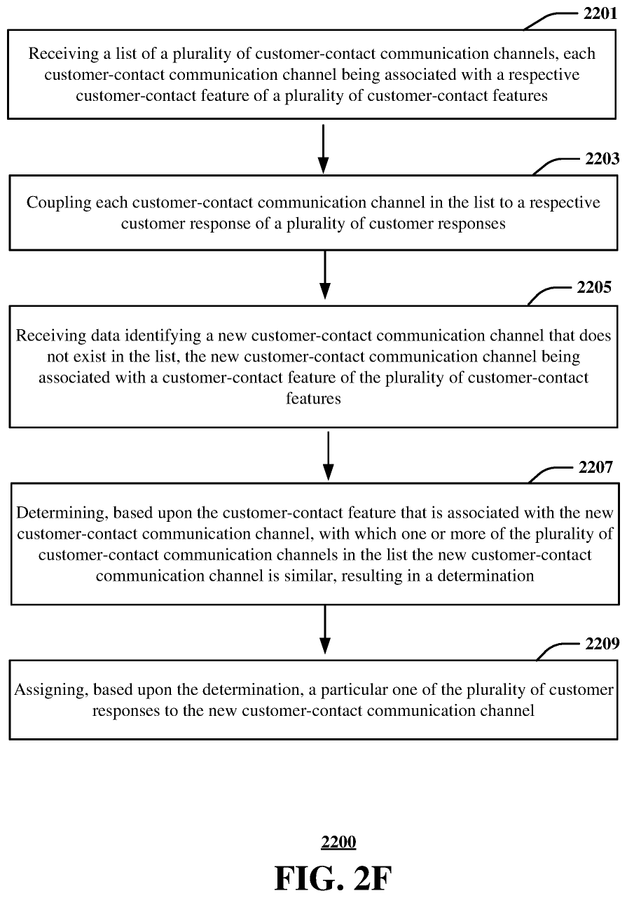

Referring now to FIG. 2A, this is a block diagram illustrating an example, non-limiting embodiment of a system 200 (which can function fully or partially within the communication network of FIG. 1) in accordance with various aspects described herein. As seen, there are a number of contact channels 202A, 202B, 202C (while three contact channels are shown in this example, any desired number of contact channels can be used). Information identifying the Contact Channels 202A, 202B, 202C (e.g., in the form of a list or the like) is input to a process that performs Channel Feature Encoding 204. An output from Channel Feature Encoding 204 is sent to a process that performs Topic Organization 214 and to a process that performs Learning of Action and Response 216. An output from Learning of Action and Response 216 is stored in Database 208B. In addition, an output from Channel Feature Encoding 204 is sent to a process that performs Model-based Action Proposal 206 (which also receives an input from Database 208A). In one example, Database 208A and Database 208B are the same database; in another example, Database 208A and Database 208B are different databases. Moreover, an output from Model-based Action Proposal 206 is sent to a process that performs User Action Evaluation 212 (which also receives input in the form of User Interactions 210). Further, an output from User Action Evaluation 212 is sent to Learning of Action and Response 216.

Still referring to FIG. 2A, it is seen that various embodiments can provide: (a) A mechanism that facilitates answering the question of how to reach out to people across different channels; (b) A mechanism that facilitates novel encoding of new channels (see, e.g., element 204); (c) A mechanism that facilitates specific model adjustment and mapping between other channels (see, e.g., element 206); and/or (d) A mechanism that facilitates adding new channel-specific learnings and evaluation of their impact.

Referring now to FIG. 2B, this is a block diagram illustrating an example, non-limiting embodiment of a system 250 (which can function fully or partially within the communication network of FIG. 1) in accordance with various aspects described herein. As seen, various features and examples of data flow are presented. More particularly, a process that performs Channel Feature Encoding 252 receives information identifying Channels 254 and information identifying Action Features 256. In various examples, the Channels 254 can comprise (see the column labeled 254A) one or more of: VA (virtual agent); Voice Call; Messaging; and/or Retail/Tech Response. Of course, additional and/or other channels can be used as desired. Further, in various examples, the Action Features 256 can comprise (see the column labeled 256A) one or more of: Synchronous/Asynchronous; Voice, Sentiment; Politeness; Dynamics; and/or Comm Channel. Of course, additional and/or other action features can be used as desired.

Still referring to FIG. 2B, an output from Channel Feature Encoding 252 is sent to a process that performs Model Learning 258. Model Learning 258 receives other input from a process that performs Action Evaluation 260 (in addition, Model Learning 258 sends output to Action Evaluation 260). Moreover, Action Evaluation 260 receives information identifying Action/Treatment 262 and receives information identifying Response 264 (which, in turn, is received from User Interactions 266). In various examples, the Action/Treatment 262 can comprise (see the column labeled 262A) one or more of: Notification; Direct Passive Call; Service Disrupt; Repeat Contact; and/or Interactive Call. In various examples, the Response 264 can comprise (see the column labeled 264A) one or more of: Payment; Repeat Call; Churn; Damage Avoid; Upgrade; and/or Interview.

Referring now to FIG. 2C, this is a block diagram illustrating an example, non-limiting embodiment of a system 270 (which can function fully or partially within the communication network of FIG. 1) in accordance with various aspects described herein. As seen, this system 270 includes Channels 274, Channel Feature Encoding 272, Action Features 276, Model Learning 278, Action Evaluation 280, Action/Treatment 282, Response 284, and User Interactions 286. Each of these elements 274, 272, 276, 278, 280, 282, 284, and 286 is generally structured as (and operates in a similar manner to) each of the corresponding elements of FIG. 2A. Further, each of Action Features column 276A, Action/Treatment column 282A, and Response column 284 corresponds to a respective element of FIG. 2A. Moreover, Channels column 274A corresponds to Channels column 254A of FIG. 2B, with the difference being that in this FIG. 2B there is a new (e.g., previously unknown) Action Channel “X”. In operation of system 270, when a new action channel (e.g., the depicted channel “X”) evolves, its properties can be used to measure similarity distance to existing action channels and to automatically generate an encoding of the channel. In one specific example, a similarity distance can be based upon a number of features of the new action channel that match (or are similar to) a number of features of a given one of the existing action channels.

Referring now to FIG. 2D, various steps of a method 2000 according to an embodiment are shown. As seen in this FIG. 2D, step 2001 comprises obtaining a list of a plurality of communication channels, each communication channel being associated with at least one respective feature of a plurality of features. Next, step 2003 comprises correlating each communication channel in the list with at least one respective user response of a plurality of user responses. Next, step 2005 comprises receiving an identification of a new communication channel that does not exist in the list, the new communication channel being associated with at least one feature of the plurality of features. Next, step 2007 comprises determining, based upon the at least one feature that is associated with the new communication channel, with which one or more of the plurality of communication channels in the list the new communication channel is similar, resulting in a determination. Next, step 2009 comprises assigning, based upon the determination, at least one of the plurality of user responses to the new communication channel. In one embodiment, this determination may be a process of capability overlap for an action feature. For example, in voice-based channels, the system may opt to use questions that seek a response from the user such that those responses are analyzed for both sentiment and agreement. If the system attempts to map to a non-voice channel (e.g., text messaging or email), the ability to discern sentiment for individual transactional responses (e.g., simple “yes”, “no”, or “I don't want to do that now”) may not be available. In this scenario, the use of features that depend on sentiment-based analysis would be excluded from the mapping. In another embodiment, this determination may be based on the quality or precision of an action feature involved in the channel. In another example, the action feature is engagement with the current channel and the system is trying to map between a video-based interaction and one that uses an in-person agent (human or automated). The original video-based channel may have the capability to detect a wide variance of engagement from fully attentive (e.g., eyes open, following specific graphics on screen) to mild inattention (e.g., looking away or slow confirmation responses when prompted with questions). However, the agent-based channel relies on a secondary system (or human interpretation) to indicate a level of engagement which may be too poor or infrequent for the underlying action feature and model learning to be effective. In both embodiments, step 2007 may assign different action features for the channel mapping or may restrict or otherwise discourage mapping interactions and responses between two channels.

Still referring to FIG. 2D, in one example, the determining can be based upon satisfying a similarity threshold (wherein there can be more than one similar existing communication channel). In another example, when it is determined that there are more than one similar existing communication channels, then one or more other factors can be utilized to determine which one of the candidates that meets the similarity threshold (e.g., exceeds the similarity threshold) should be selected. In another example, a particular candidate can be chosen because it is the most effective (e.g., by business metric, contextual agreement, or customer satisfaction).

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2100 according to an embodiment are shown. As seen in this FIG. 2E, step 2101 comprises receiving identification of a plurality of communication channels. Next, step 2103 comprises receiving, for each communication channel of the plurality of communication channels, identification of one or more respective associated features of a plurality of features. Next, step 2105 comprises correlating each communication channel of the plurality of communication channels with one or more respective customer responses of a plurality of customer responses. Next, step 2107 comprises receiving identification of a new communication channel. Next, step 2109 comprises receiving, for the new communication channel, identification of one or more associated features of the plurality of features. Next, step 2111 comprises determining, based upon the one or more features that are associated with the new communication channel, with which particular one or more of the plurality of communication channels the new communication channel corresponds, resulting in a determination. Next, step 2113 comprises associating, based upon the determination, a particular one of the plurality of customer responses with the new communication channel.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2F, various steps of a method 2200 according to an embodiment are shown. As seen in this FIG. 2F, step 2201 comprises receiving a list of a plurality of customer-contact communication channels, each customer-contact communication channel being associated with a respective customer-contact feature of a plurality of customer-contact features. Next, step 2203 comprises coupling each customer-contact communication channel in the list to a respective customer response of a plurality of customer responses. Next, step 2205 comprises receiving data identifying a new customer-contact communication channel that does not exist in the list, the new customer-contact communication channel being associated with a customer-contact feature of the plurality of customer-contact features. Next, step 2207 comprises determining, based upon the customer-contact feature that is associated with the new customer-contact communication channel, with which one or more of the plurality of customer-contact communication channels in the list the new customer-contact communication channel is similar, resulting in a determination. Next, step 2209 comprises assigning, based upon the determination, a particular one of the plurality of customer responses to the new customer-contact communication channel.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, a mechanism can use multi-dimensional, reactive and adaptive features to: (a) Support understanding of a new communication channel and/or a new treatment (such as a type of contact or a service disruption) that is provided to a customer; (b) Support understanding of a response (to the new communication channel and/or the new treatment) from the customer; and/or (c) Facilitate an adjustment of treatment actions at the appropriate moment to evaluate treatment effectiveness. In one example, a fuzzy match approach can be used to enable future treatment methods utilizing a current process (this can provide for flexibility and account for the unknown).

In one example, a one-dimensional categorical variable can be converted to multi-dimensional numerical variables in a way that a new category can be easily scored by existing models. In one embodiment, a categorical expansion may involve the mapping of one specific value to a pre-determined or pre-learned list of alternate values. For example, the simple phrase “video chat” may map to usages observed on a customer account. For one customer, these video chat usages may be determined to be one-way video communications with a subscription service on meditation, while another customer's video chat usages may be four-way communication with family members on a mobile network that reside in two different countries. In another embodiment, the categorical conversion may involve a semantic expansion for related features in other categories. Here the phrase “online games” may be expanded semantically to imply console-based games, phone- or mobile-based games, or even in-home virtual reality-based games. In one example, the system may convert the feature to all of these possibilities (e.g., in sales and marketing actions on a video-based channel) and in another example, the system may convert the feature to only the active possibility (e.g., the current communication channel is an app-based video chat, so only mobile-based games are considered). In yet another embodiment, the system may convert a single categorical variable into multiple features based on a workflow dependency unraveling. For example, the utterance “down payment” in a voice-based channel may be converted to treatment features that involve several actions that have a temporal dependency. In this example, a down payment may include scheduling of a first action, contacting the customer again for a subsequent payment, evaluating the remaining balance based on date and amount of the payment, and repeating this process again until the full balance has been received. While these are only a few examples of categorical feature expansion, the inclusion of other channel-, action-, or response-based features may also be considered depending on how the system is implemented with regards to customer interactions.

In various examples, treatment method & business rule related features can include: (a) Business domain knowledge for each treatment/channel or a combination of them can be utilized for categorization; and/or (b) New unknown treatment/channel can be mapped accordingly by business domain knowledge, which can be utilized in model for predicting/simulating/estimating the effectiveness of any model outcome. In various specific examples, one or more of the following can be utilized: (a) Word similarity score for all treatment options; (b) A combination of levels of easy to reach customer for all treatment options; (c) A combination of types of customer treatment for all treatment options; and/or (d) Friendliness level for all combination of treatment options.

In various examples, customer feedback corresponding to each treatment method and combinations of the treatment methods at different time point of customer collection cycle can be implemented via one or more of: (a) Projected Customer-initiated feedback for each of all possible treatment options at different days in customer collection cycle (e.g., inbound/outbound call, churn, restore, cure, etc.); and/or (b) Projected business-initiated feedback for each of all possible treatment options at different days in customer collection cycle (e.g., inbound/outbound call, suspend, restore, cure, etc.). In various specific examples, each individual customer can have different frequencies of responding to each treatment method at different timepoints. This can be reflected, for example, in one or more of the following: (a) Individual customer behavior history in particular domain such as finance, treatment and collection outcomes; (b) Behavior of previous care—preferred channel, preferred way of interaction (e.g., based on prior successes); (c) Adaptive on individual as well as cohort-based behavior (e.g., different task domain as cohort); and/or (d) Delivery device for treatment (such as personal devices (cell, landline), TV, email, etc.).

In various examples, historical statistical features can be utilized (e.g., levels of historical frequency for one single treatment in all treatment possible options).

In various examples, new method/channel creation can be based on best outcomes from simulation(s). Such simulation(s) can comprise: (a) Simulate all the possible space/options to identify a best combination of features of a brand-new unknown treatment/channel to achieve the best performing outcome; and/or (b) Business can create this brand-new unknown treatment/channel and determine if it works for customer and/or business based on this best combination of features. In one embodiment, these simulations are executed in-place during model learning. In another embodiment, these simulations are executed in batch as a follow-up process to several user interactions. In yet another embodiment, these simulations may internally generate treatment and response features that are wholly synthetic in nature (but based on real customer models) to test model outcomes in adversarial situations. For example, in testing model outcome for a new virtual reality-based channel, the simulation may simulate scenarios where an adversarial third party (e.g., virtual colleagues of the customer, an avatar-based virus, or one or more virtual “twin” identities) collude to introduce unrelated responses or negative-sentiment action features into the communication channel.

Reference will now be made to a description of a system according to an embodiment. More particularly, in this embodiment:
1. The system observes feedback from multiple channels (see, e.g., elements 202A,B,C of FIG. 2A; element 254 of FIG. 2B; element 274 of FIG. 2C) and actions in those channels (see, e.g., element 204 of FIG. 2A; element 252 of FIG. 2B; element 272 of FIG. 2C)
   a) The coupling is both the channel (e.g., text, audio, video example, voice prompt) and a workflow step (e.g., digital step, physical operation, user response)
2. The system self-organizes a topic (see, e.g., element 214 of FIG. 2A) and context solution (see, e.g., action feature encoding and channel feature encoding 204 and 216 of FIG. 2A; 252 and 260 of FIG. 2B; 272 and 280 of FIG. 2C)
   a) The organization can be supervised (e.g., based on known historical treatments and responses) and/or unsupervised (e.g., based on clusters or groupings of similar treatments and responses)
   b) The organization can use knowledge graph and/or other methods (e.g., to determine which attributes are important features for the treatment)
3. The system aggregates success rates for proposed solution and customer interaction (see, e.g., element 208A of FIG. 2A)
   a) Optimize by a target variable (e.g., decreased churn, satisfaction measurement, etc.)
   b) Optimize by available channel or action features
   c) Optimize by various customer segments as defined by customer profiles, demographics, and/or business rules
4. The system detects a gap in existing solutions and/or available channels (see, e.g., element 212 of FIG. 2A; 260 of FIG. 2B; 280 of FIG. 2C)
   a) The gap can be explicit threshold (e.g., determine when self-organization fails) and/or can be human triggered (e.g., escalated problems through a communication channel)
   b) The gap can be determined as a result of a novel channel being discovered c) The gap can be determined as a result of a novel channel being submitted by one or more users (e.g., want to interact with “TikTok video demonstration”)
5. The system finds most similar existing solution(s) and channel(s)
6. The system proposes a new channel or workflow step (see, e.g., element 208B of FIG. 2A)
   a) The system proposal can result from allowing automated “best fit”
   b) The system proposal can result from allowing interactive choice and promotion as new channel/solution
   c) Optionally, the system can request user assistance for proper refactor into new channel (e.g., how do you render text into 3D graphics?)
7. The system integrates new combined channel and workflow step for future workflow interactions
   a) In one example, include metrics in future interactions to validate the quality and impact of addition

Reference will now be made to the following Use Case examples according to various embodiments: (a) Apply existing model to any new treatment(s) and/or channel(s) which were not used in model training; (b) Provide new mechanism(s) for initial marketing forecasting (e.g., to simulate marketing potential for new mechanism that was never tested in real world based on existing mechanism(s)); (c) Provide new communication channel for effectiveness estimation/simulation (e.g., to simulate effectiveness of brand new communication channel based on existing communications that have been tested); and/or (d) Provide new method/channel creation based on simulation outcome (e.g., simulate all possible space/options to identify a combination of features that achieve best outcome, and create one or more treatment method(s) and/or channel(s) that is close (and/or that captures one or more aspects of the best combination)).

Reference will now be made to the following domains/use cases/methodologies according to various embodiments: (a) In medical treatment when a rare orphan disease occurs, seeking most similar disease treatment strategy using learnings from current disease/treatment base; (b) In biology, new species discovered, mapping using current knowledge base to identify most similar species based on relevance to aspects of practices with certain objectives (e.g. environmental survival rate, relation with other species, stats with human interaction, etc.); (c) New product development in manufacturing; (d) New gadget (mechanism) for initial market forecast; (e) New channel for CRM communication, evaluation of effectiveness; and/or (f) Escalation to others to get outside help (e.g., can't fix by self, need qualified professional or explicit help that is out of scope)—the system can boost priority and attempt to find those other experts.

As described herein, various embodiments can provide one or more of the following benefits: (a) Save the effort of testing unknown treatment(s) and/or/channel(s) beforehand to evaluate the effectiveness of the unknown treatment/channel; (b) Result in a large cost saving from deployment of resources within a company (e.g., extra equipment, specific services, repairs, or modifications) and the total amount of time of human engagement within a company (e.g., from a business perspective the amount of time with an expert in consultative, diagnostic and repair, or negotiating capacities); (c) No need to harm the customer business relationship by deploying different AB testing strategies on unknown treatment(s) and/or channel(s); (d) To be able to find the most optimal treatment(s) and/or channel(s) without having to test every single unknown treatment/channel exhaustively; and/or (e) Provide a business prior estimation/simulation of future analysis/ML topics for any unknown treatment(s) and/or channel(s).

As described herein, certain conventional mechanisms have various disadvantages. For example, when new channels emerge, using fixed or existing treatment options in a collection process as a surrogate are often not effective or enticing to customers to pay their bills. In this regard, various embodiments can provide for one or more of the following: (a) A process that is not monotonous; (b) A process that enables an expansion of options offered for a collection treatment strategy (wherein such options meet a customer's true intent/needs); (c) A process that can estimate new/unknown method's effectiveness with existing models; (d) A process that enables an understanding of a customer's preference for receiving new communication channel; (e) A process that enables flexible collection treatment options; (f) A process that is able to adapt effectively to a customer's preference to objectives of tasks at hand; (g) A process that is personable; and/or (h) A process that enables an expansion of system level functions.

As described herein, various embodiments provide the flexibility to anticipate unknown future treatment(s) and/or channel(s) without compromising business goals and effectiveness.

As described herein, various embodiments can provide similarity-based categorization for collection treatment incorporating future CRM (Customer Relationship Management) channels.

As described herein, various embodiments can provide a method and a modeling mechanism using existing channels to project/simulate future (e.g., unforeseen) channels. Various embodiments can be used in many different domains (for instance, patient care, remote learning). In various examples, any domain that uses a communication channel as part of a user treatment process can benefit from various aspects described herein.

As described herein, various embodiments can provide a mechanism to flexibly describe communication channels so that whenever there is a new channel, the new communication channel can be encapsulated using the knowledge and the dimension that had been used to describe the old channel(s) and the old history (e.g., historic data that exists from measuring effectiveness).

As described herein, various embodiments can provide for building a model to represent a new communication channel in multiple dimensions.

As described herein, old (existing) communication channels can be dissected to determine their properties, and then those properties can be used as a measurement of similarity to a new communication channel. In one example, the similarity of the properties can be used to identify (and/or develop a portrait of) a new channel. In one example, historic data that is known about the old (existing) channel can be used (e.g., a customer's reaction to the old (existing) channel).

As described herein, various embodiments can use multi-dimensional, reactive, adaptive feature(s) to support the understanding of a new treatment channel to a customer, to support the understanding of responses of the customers from the old (existing) channel, and then to adjust the treatment actions (e.g., based on the prior responses) at the appropriate moment.

As described herein, various embodiments can facilitate encapsulating the new channel and then use that as part of a next best action potential (this can be done, for example, without interrupting an existing process).

As described herein, various embodiments can provide for a new unknown treatment channel to be mapped accordingly (e.g., by certain business domains).

As described herein, various embodiments can use training data of one or more old (existing) channels to train a new model.

As described herein, various embodiments can translate an old (existing) channel for the new model. In one example, this can be through the path of using multiple dimension representation for the old channel and then similar multiple dimension representation of the new channel (this can reduce the problem to those multiple dimensions, so that they will be consistent). Then, the old (existing) data that is available can be used for training.

As described herein, various embodiments can use as a treatment a particular type of message sent over a communication channel. For example, a friendly text message versus a not so friendly text message (for instance: please pay your bill versus if you don't pay your bill, you are going to get blocked; or please pay your bill versus if you don't pay your bill your account will be suspended). In various embodiments each of the two previous options (friendly text message versus non so friendly text message) can be considered different treatments, even though they are carried over the same type of communication channel (text message in this example).

In various examples, a treatment can comprise a combination of the communication channel plus the content that is provided to the customer (wherein different multiple dimensions can be used to represent the treatment).

In various examples, historical statistical data (such as how a customer responds to friendly versus not so friendly) can be used in determining a desired treatment option.

As described herein, various embodiments can facilitate channel creation based on best outcome from simulation (a best outcome can be, for example, a highest success rate for a bill pay or for a conversion or the like).

In various examples, a treatment can comprise a reminder and/or an automated communication.

In various examples, a treatment can comprise a communication channel as well as one or more properties of the communication channel as well as the content that is desired to be communicated.

In various examples, for a voice channel a virtual agent can sound monotonous or can sound more like a human voice.

As described herein, various embodiments can facilitate creating a new model by characterizing actions and representing them in a way that can be translatable across the different channels.

As described herein, various embodiments can observe feedback from multiple channels.

As described herein, various embodiments can implement self organizing of different topic and/or context of the solution. In various examples, this can be supervised and/or can be user knowledge graph.

As described herein, various embodiments can aggregate historic data and the success rate (e.g., reduce churn, customer satisfaction) for response with the proposed solution and customer interaction. In one example, a goal can be represented by an objective function.

As described herein, various embodiments can operate via use of a similarity measure.

As described herein, various embodiments can operate by taking all the existing treatment options and breaking them down into different kinds of attributes to, for example, use a knowledge graph and represent each of the properties of each of these treatment options. In another example, a similarity measure can be used to identify a new channel having new properties that are similar (or the same as) existing properties. In one specific example, a mechanism can compare those properties to find (or identify) the most similar to a particular action.

In various examples, representation into a multiple dimensional space can be hierarchical. In one specific example, a graph can be used to represent properties and then based on those properties when there is a new action the action can be defined in terms of those properties. Further, the similarity measure can be used again (e.g., convert the multiple dimension categories into one dimension for similarity; then find (or identify) the most similar).

As described herein, various embodiments can use as data points past treatment actions and then this data can be leveraged for the future (e.g., inform a training set of historic data, success rates of past actions, etc.). In one example, data can be incorporated into any desired business goal/application.

As described herein, various embodiments can characterize things that have been observed in a customer flow, can organize (or link) that to the steps the customer has taken in that flow, and then perform aggregating of success rates.

As described herein, various embodiments can perform channel encoding in order to compare the workflows across the different channels. So, for example, if there is something that's in an email thread, a potential customer problem can be identified and dealt with (e.g., friendly reminder to customer, or escalation of issue). In other examples, the encoding can be in the context of different channels (e.g., make sure that such channels can be allowed). In another example, a comparison can be made across the different channels (e.g., email, a digital bot, a virtual agent (VA), etc.).

In various examples, a search can be performed for different channels (e.g., email, a digital bot, a virtual agent (VA), etc.) amongst all of the different workflows (for instance, a workflow can be something like a billing problem, or fixing something, or a follow up, or marketing). The searching can find the alignment of whatever that task was.

As described herein, various embodiments can operate to find a potential match (such as between treatments and/or between channels). In one example, a match can be to take an action or to not take an action (for instance, send an email reminder or don't send an email reminder). In another example, a match can be how do you render text into 3D graphics? In another example, a match can be what happens as customer experience, customer interaction (e.g., metaverse interactions, virtual interaction with a customer's house or the equipment itself).

As described herein, various embodiments can encode current business rules and actions (e.g., without requiring a fixed set of treatment options). In one example, there can be an initial set of business options, wherein any new evolution can be accommodated.

In one example, a historic analysis shows that a particular customer prefers to interact with a live agent (as opposed to a virtual agent). This information can be used in designing an appropriate treatment. In another example, a historic analysis shows that a particular customer prefers to interact with a virtual agent having a voice of a particular gender. Again, this information can be used in designing an appropriate treatment. In another example, a historic analysis shows that a particular customer prefers to interact with an agent (live or virtual) having a voice in a given frequency range. Again, this information can be used in designing an appropriate treatment.

In various examples, a treatment can be presented in a colloquial manner so that the customer feels most comfortable. In one example, a treatment can be created dynamically in an optimized fashion for a customer.

As described herein, various embodiments can leverage what attribute (and/or property) works in order to dynamically create a new treatment.

As described herein, various embodiments can provide for converting a one-dimensional categorical variable into a multiple-dimensional numerical variable to describe a multi-dimensional representation of an existing treatment method and to expand to a potential future treatment method.

As described herein, various embodiments can learn using training data (e.g., old or existing treatment/channels).

As described herein, a treatment (such as a particular communication channel) can be defined by a characteristic such as “friendly” or “non-friendly”.

As described herein, various embodiments can learn via use of historic data (e.g., how customer responds to particular treatment (for instance, friendly message or less friendly message)).

As described herein, various embodiments can utilize multi-dimensional representations.

As described herein, a virtual agent can be utilized for communication. In one specific example, a type of voice of a virtual agent can be one of the multiple dimensions).

As described herein, various embodiments can provide an ability to cross-apply different treatments.

As described herein, various embodiments can provide for implementation via a gadget (e.g., a device, a method).

As described herein, “success” with regard to a treatment can be defined in the context of one or more business goals.

As described herein, various embodiments can utilize a knowledge graph and/or one or more similarity measures.

As described herein, a new channel can be defined in the context of how text is rendered.

As described herein, various embodiments can provide for dynamically learning and/or dynamically creating a new treatment method (e.g., use a most soothing voice frequency).

As described herein, various embodiments can operate as follows: (a) when faced with a new channel; (b) determine closest match in prior interactions; and (c) use that as the new response.

As described herein, various embodiments can operate such that a desired response (e.g., payment) is independent of the channel and a goal is to simply get the desired response.

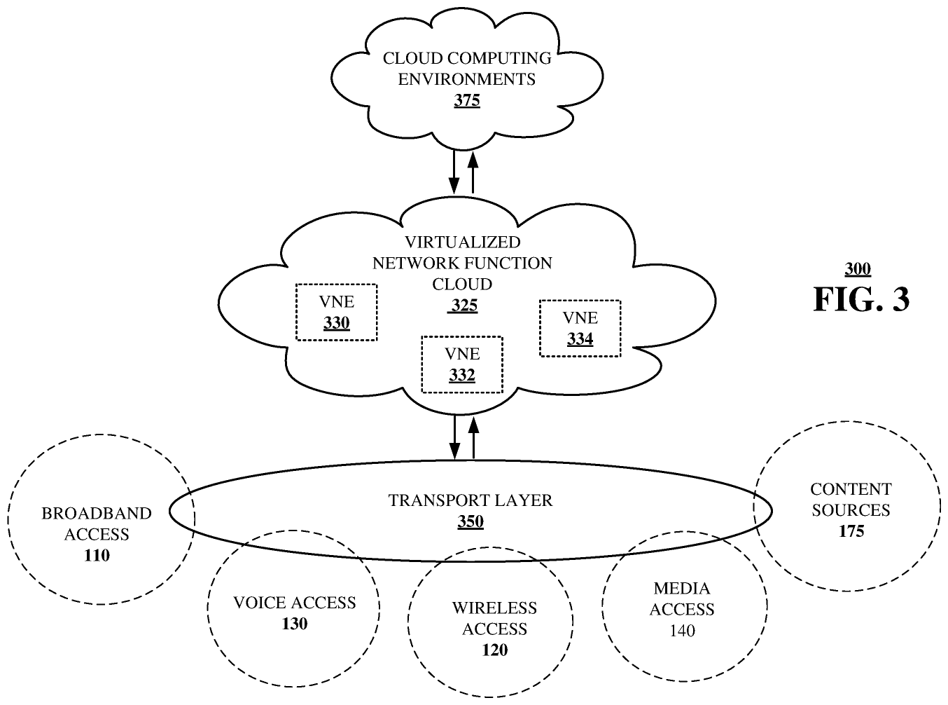

Referring now to FIG. 3, a block diagram 300 is shown illustrating an example, non-limiting embodiment of a virtualized communication network in accordance with various aspects described herein. In particular, a virtualized communication network is presented that can be used to implement some or all of the subsystems and functions of system 100, some or all of the subsystems and functions of system 200, some or all of the subsystems and functions of system 250, some or all of the subsystems and functions of system 270, and/or some or all of methods 2000, 2100, 2200. For example, virtualized communication network 300 can facilitate in whole or in part categorizing, simulating, and implementing communication channels and/or business actions (e.g., in the context of customer relationship management).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

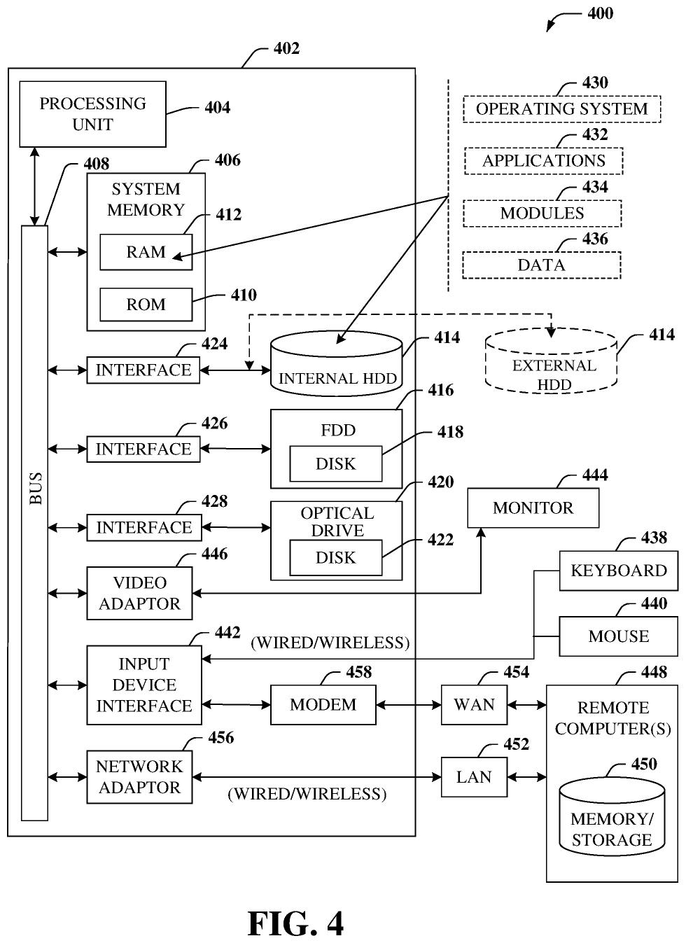

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part categorizing, simulating, and implementing communication channels and/or business actions (e.g., in the context of customer relationship management).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

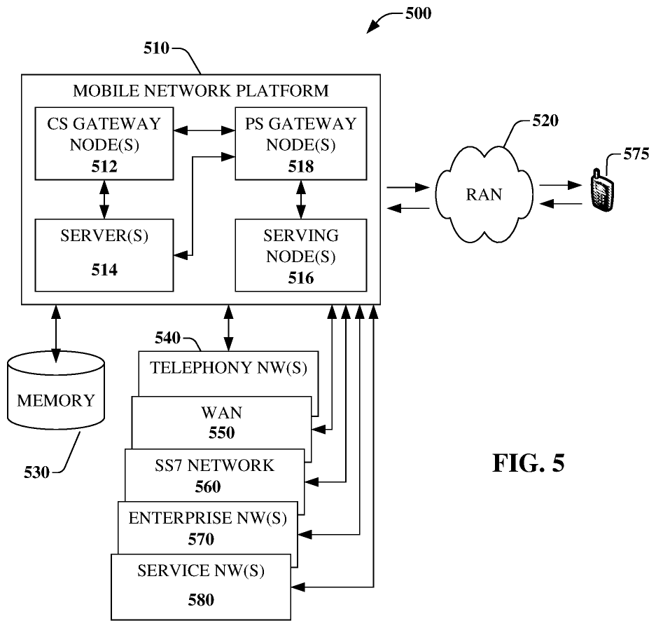

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part categorizing, simulating, and implementing communication channels and/or business actions (e.g., in the context of customer relationship management). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

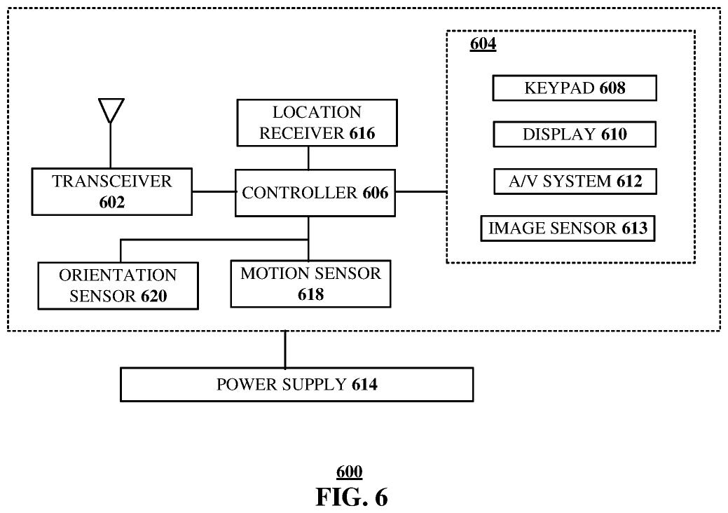

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part categorizing, simulating, and implementing communication channels and/or business actions (e.g., in the context of customer relationship management).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically categorizing, simulating, and implementing communication channels and/or business actions) can employ various AI-based schemes for carrying out various embodiments thereof. Moreover, the classifier can be employed to determine a ranking or priority of each communication channel and/or business action. A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the communication channels and/or business actions will provide the most benefit.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining a list of a plurality of communication channels, each communication channel being associated with at least one respective feature of a plurality of features;
correlating each communication channel in the list with at least one respective user response of a plurality of user responses;
receiving an identification of a new communication channel that does not exist in the list, the new communication channel being associated with at least one feature of the plurality of features;
determining, based upon the at least one feature that is associated with the new communication channel, with which one or more of the plurality of communication channels in the list the new communication channel is similar, resulting in a determination; and
assigning, based upon the determination, at least one of the plurality of user responses to the new communication channel.

2. The device of claim 1, wherein:
each user response of the plurality of user responses is a customer response; and
the operations further comprise contacting a customer via the new communication channel in order to achieve a desired customer response.

3. The device of claim 1, wherein the determining determines with which one of the plurality of communication channels in the list the new communication channel is most similar.

4. The device of claim 1, wherein the determining determines with which of a number of the plurality of communication channels in the list the new communication channel is similar, wherein the number is greater than one, and wherein being similar comprises being similar within a boundary of a similarity threshold.

5. The device of claim 1, wherein:
the correlating comprises utilization of model learning; and
the model learning comprises machine learning, artificial intelligence, reinforcement learning, or any combination thereof.

6. The device of claim 1, wherein:
the list is obtained from a first database; and
an indication of an assignment of a particular one of the plurality of user responses to the new communication channel is stored in a second database.

7. The device of claim 6, wherein the first database and the second database are a same database.

8. The device of claim 1, wherein:
each communication channel in the list is associated with more than one respective feature of the plurality of features;
each communication channel in the list is correlated with more than one respective user response; and
the new communication channel is associated with more than one feature of the plurality of features.

9. The device of claim 1, wherein the assigning comprises assigning more than one of the plurality of user responses to the new communication channel.

10. The device of claim 1, wherein the determining comprises comparing the at least one feature that is associated with the new communication channel with each feature of the plurality of features associated with existing channels.

11. The device of claim 1, wherein the plurality of features comprises:
synchronous/asynchronous; voice; sentiment; politeness, dynamics, or any combination thereof.

12. The device of claim 1, wherein the plurality of communication channels comprises: virtual agent (VA); voice call; video call; messaging; retail/tech response;
virtual reality interface; or any combination thereof.

13. The device of claim 1, wherein the plurality of user responses comprises:
payment; repeat call; churn; damage avoidance; upgrade; interview; cross-sell; or any combination thereof.

14. The device of claim 1, wherein the operations further comprise:
obtaining another list of a plurality of actions; and
correlating each action in the another list with at least one respective user response of the plurality of user responses.

15. The device of claim 14, wherein the assigning the at least one of the plurality of user responses to the new communication channel is further based upon a selected one of the actions.

16. The device of claim 15, wherein the plurality of actions comprises: notification;
direct passive call; service disrupt; repeat contact interactive call; or any combination thereof.

17. A non-transitory machine-readable medium comprising executable instructions that, when executed by a processing system including a processor, facilitate performance of operations, the operations comprising:
receiving identification of a plurality of communication channels;
receiving, for each communication channel of the plurality of communication channels, identification of one or more respective associated features of a plurality of features;
correlating each communication channel of the plurality of communication channels with one or more respective customer responses of a plurality of customer responses;
receiving identification of a new communication channel;
receiving, for the new communication channel, identification of one or more associated features of the plurality of features;
determining, based upon the one or more features that are associated with the new communication channel, with which particular one or more of the plurality of communication channels the new communication channel corresponds, resulting in a determination; and
associating, based upon the determination, a particular one of the plurality of customer responses with the new communication channel.

18. The non-transitory machine-readable medium of claim 17, wherein:
the determining determines with which particular one of the plurality of communication channels the new communication channel most closely corresponds;
the identification of a plurality of communication channels is received as a list;
the list identifies, for each communication channel the one or more respective associated features;
each of the plurality of communication channels and the new communication channel are part of a customer relationship management (CRM) process; and
each of the plurality of customer responses results from a respective interaction with a particular customer.

19. A method comprising:
receiving a list of a plurality of customer-contact communication channels, each customer-contact communication channel being associated with a respective customer-contact feature of a plurality of customer-contact features;
coupling each customer-contact communication channel in the list to a respective customer response of a plurality of customer responses;
receiving data identifying a new customer-contact communication channel that does not exist in the list, the new customer-contact communication channel being associated with a customer-contact feature of the plurality of customer-contact features;
determining, based upon the customer-contact feature that is associated with the new customer-contact communication channel, with which one or more of the plurality of customer-contact communication channels in the list the new customer-contact communication channel is similar, resulting in a determination; and
assigning, based upon the determination, a particular one of the plurality of customer responses to the new customer-contact communication channel.

20. The method of claim 19, wherein:
the determining determines with which one of the plurality of customer-contact communication channels in the list the new customer-contact communication channel is most similar;
each customer-contact communication channel in the list is associated with a plurality of respective customer-contact features;
each customer-contact communication channel in the list is coupled to a plurality of respective customer responses;
the new customer-contact communication channel is associated with a plurality of customer-contact features; and
a plurality of customer responses are assigned to the new customer-contact communication channel.
